(19) United States
(12) Patent Application Publication
(10) Pub. No.: US 2020/0239767 A1
(43) Pub. Date: Jul. 30, 2020

(54) SHORT DURATION CHEMILUMINESCENT COMPOSITION

(71) Applicant: Armtec Defense Products Co., Coachella, CA (US)

(72) Inventors: Rachel Newell, Coachella, CA (US); Jeff Smith, Coachella, CA (US); Alicia Aispuro, Coachella, CA (US)

(21) Appl. No.: 16/590,242

(22) Filed: Oct. 1, 2019

Related U.S. Application Data
(63) Continuation of application No. 15/234,874, filed on Aug. 11, 2016, now abandoned.
Application No. 15/234,874 is a continuation of application No. 13/911,036, filed on Jun. 5, 2013, now abandoned.
(60) Provisional application No. 61/655,743, filed on Jun. 5, 2012.
(60) Provisional application No. 61/670,392, filed on Jul. 11, 2012.

(51) Int. Cl. C09K 11/07; F42B 30/00; F21K 2/06; F42B 12/40; F21W 131/40

(52) U.S. Cl. CPC C09K 11/07; F42B 30/00; F21K 2/06; C09K 2211/10; F42B 12/40; F21W 2131/40; F42B 30/006

(57) ABSTRACT

One aspect of the invention relates to chemiluminescent compositions comprising an oxalate composition, an activator composition and a H₂O₂-decomposition catalyst. Another aspect of the invention relates to chemiluminescent compositions comprising an oxalate composition, an activator composition and a peroxyoxalate catalyst. Another aspect of the invention relates to chemiluminescent systems comprising a chemiluminescent composition disclosed herein, wherein the oxalate composition and the activator composition are stored separately until activation. Another aspect of the invention relates to chemiluminescent systems comprising a chemiluminescent composition disclosed herein, wherein the oxalate composition, the activator composition, the peroxyoxalate catalyst, and/or the H₂O₂-decomposition catalyst are stored separately until activation. Another aspect of the invention relates to methods for initiating the chemiluminescent compositions and/or the chemiluminescent systems disclosed herein.

### PRIORITY CLAIM

This application is a continuation of U.S. patent application Ser. No. 15/234,874, titled Short Duration Chemiluminescent Composition, filed Aug. 11, 2016, which is a continuation of U.S. patent application Ser. No. 13/911,036, titled Short Duration Chemiluminescent Composition, filed Jun. 5, 2013, which claims the benefit of and priority to U.S. Provisional Patent Application No. 61/655,743, titled Self Heating Chemiluminescent Composition, filed on Jun. 5, 2012, and U.S. Provisional Patent Application No. 61/670,392, titled Self Heating Chemiluminescent Composition, filed on Jul. 11, 2012, all of which are incorporated herein by reference thereto.

### TECHNICAL FIELD

This invention relates to chemiluminescent compositions that produce heat and/or light when activated, and applications thereof.

### BACKGROUND

Chemiluminescent devices based on peroxyoxalate reactions are well known in the art. These reactions utilize the reaction between a bis-oxalate ester such as bis(2,4,6-trichlorophenyl) oxalate (TCPO) or bis(2-carbopentyloxy-3,5,6-trichlorophenyl) oxalate (CPPO) and a peroxide such as hydrogen peroxide. This reaction generates an energetic intermediate that can transfer energy to a fluorescent dye, which re-emits it as light. In most applications, the bis-oxalate ester and fluorescent dye are dissolved in a solvent to form an oxalate component, and the hydrogen peroxide is dissolved in a solvent to form an activator component. The reaction is initiated by mixing the oxalate component and the activator component. Examples of chemiluminescent systems known in the art may be found in one or more of the following U.S. Pat. Nos. 3,749,679; 3,391,068; 3,391,069; 3,974,368; 3,557,233; 3,597,362; 3,775,336; and 3,888,786, which are incorporated herein by reference.

A variety of applications require very close control of the reaction rate of peroxyoxalate reactions. Commercially available light sticks are available in durations ranging from 5 minutes to over 24 hours. According to the Arrhenius equation k=Ae^{-Ea/kbT}, the reaction rate can be influenced by changing the activation energy (Eₐ) and/or the reaction temperature. Traditionally, rate control is achieved by using a catalyst that affects the activation energy. The peroxyoxalate reaction is catalyzed by bases and inhibited by acids, so the reaction rate can be adjusted by adding suitable acids and bases. However, the advertised duration of a formulation which is rate controlled catalytically is only accurate for a narrow range of operating temperatures. When the temperature is too low, the reaction rate may be so slow that a light stick produces little or no light. Likewise, a light stick activated at a high temperature may have such a fast reaction rate that the reaction duration is significantly shorter than advertised. Additionally, a typical peroxyoxalate reaction has a “tail” of dim light that continues for a significant period of time after the advertised duration. However, for certain training ammunition payloads (e.g. 40 mm training ammunition payloads), a short duration pulse of light that extinguishes quickly may be desirable to simulate the flash from an energetic payload.

Thus, there is a need to provide a chemiluminescent system that can be used at a wider range of temperatures. Furthermore, there is a need to develop a chemiluminescent system that is relatively independent of the ambient temperature. There is also a need to develop a chemiluminescent system that extinguishes quickly after an initial bright flash of light.

### SUMMARY

One aspect of the disclosure relates to a chemiluminescent composition comprising an oxalate composition and an activator composition, wherein:

the oxalate composition comprises an oxalate;

the activator composition comprises at least about 2.5% H₂O₂ and an activator solvent; and

a H₂O₂-decomposition catalyst.

Another aspect of the disclosure relates to a chemiluminescent composition comprising an oxalate composition, an activator composition and a peroxyoxalate catalyst, wherein:

the oxalate composition comprises an oxalate; and

the activator composition comprises at least about 2.5% H₂O₂ and an activator solvent.

Another aspect of the disclosure relates to a chemiluminescent system comprising a chemiluminescent composition disclosed herein:

an oxalate container containing an oxalate composition therein;

an activator container containing an activator composition therein;

the oxalate container and the activator container are separated by one or more frangible barriers such that, when the one or more frangible barriers are broken, the oxalate composition and the activator composition will make contact.

Another aspect of the disclosure relates to an ammunition payload comprising a chemiluminescent system disclosed herein.

Another aspect of the disclosure relates to a method for initiating a chemiluminescent system and/or a chemiluminescent composition disclosed herein comprising contacting the ingredients of the chemiluminescent composition with each other at a first temperature to initiate the peroxyoxalate reaction.

### DETAILED DESCRIPTION

One aspect of the disclosure relates to a chemiluminescent composition comprising an oxalate composition and an activator composition, wherein:

the oxalate composition comprises an oxalate;

the activator composition comprises at least about 2.5% H₂O₂ and an activator solvent; and

a H₂O₂-decomposition catalyst.

Examples of H₂O₂-decomposition catalysts include, without limitation, metal oxides (e.g. manganese dioxide), metals (e.g. silver, platinum, and copper), oxidants (e.g. potassium permanganate) and enzymes (e.g. catalase). In certain embodiments, the oxalate composition further comprises the H₂O₂-decomposition catalyst. In certain embodiments, the H₂O₂-decomposition catalyst is stored separately from the activator and oxalate compositions.

Any solvent in which hydrogen peroxide (H₂O₂) is relatively stable, soluble or suspendable may be used as the activator solvent. Since relatively high concentrations of hydrogen peroxide may be desired, solvents which have good miscibility with hydrogen peroxide are desirable. Examples of activator solvents include, without limitation, water, triethyl citrate, triacetin, and any combination thereof.

In certain embodiments, heat is produced when the composition disclosed herein is activated, and the amount of heat produced and the rate of heat production may be controlled by adjusting the concentrations of hydrogen peroxide in the formulation and the amount and type of the H₂O₂-decomposition catalyst.

In one embodiment, the concentration of H₂O₂ in the activator composition is at least about 2.5%. In another embodiment, the concentration of H₂O₂ in the activator composition is at least about 10%. A preferred concentration of H₂O₂ in the activator composition is about 20% to about 60%. In other embodiments, the concentration of H₂O₂ in the activator composition may be as high as 100%. In alternate embodiments, the preferred concentration of H₂O₂ in the activator composition can be about 10% to about 60%.

In another embodiment, the % weight of activator composition of the chemiluminescent composition is about 30% to 70%. Other embodiments may include a different % weight of activator compound.

In another embodiment, the final concentration of H₂O₂ in the chemiluminescent composition is at least about 1%. A preferred final concentration of H₂O₂ in the chemiluminescent composition is about 2% to about 35%. In another embodiment, the final concentration of H₂O₂ in the chemiluminescent composition is at least about 5%. A preferred final concentration of H₂O₂ in the chemiluminescent composition is about 7% to about 35%. In alternate embodiments, a final concentration of the H₂O₂ in the chemiluminescent composition may be at least about 10%. In alternate embodiments, the preferred final concentration of H₂O₂ in the chemiluminescent composition may be about 5% to about 40%.

In certain embodiments, the chemiluminescent composition is triggered to emit light at a first temperature, wherein the first temperature is about −40° C. or higher. In other embodiments, the chemiluminescent composition may be triggered to emit light at a temperature of about −20° C. to about 50° C.

In certain embodiments, the temperature of the chemiluminescent composition, once the H₂O₂-decomposition catalyst contacts, is increased to a maximum temperature of about 100° C. or lower. In another embodiment, the temperature of the chemiluminescent composition, once the H₂O₂-decomposition catalyst contacts, is increased to a maximum temperature of about 75° C. or lower.

In certain embodiments, the time it takes for the chemiluminescent composition, once the H₂O₂-decomposition catalyst contacts, to reach the maximum temperature is about 20 seconds or shorter. In another embodiment, the time it takes for the chemiluminescent composition, once the H₂O₂-decomposition catalyst contacts, to reach the maximum temperature is about 2 minutes or shorter.

In certain embodiments, the time it takes for the chemiluminescent composition, once the H₂O₂-decomposition catalyst contacts, to reach a peak light is about 10 seconds or shorter. In another embodiment, the time it takes for the chemiluminescent composition, once the H₂O₂-decomposition catalyst contacts, to reach a peak light is about 0.5 minutes or shorter.

In certain embodiments, the time it takes for the light from the chemiluminescent composition to extinguish is about 3 seconds or shorter. In another embodiment, the time it takes for the light from the chemiluminescent composition to extinguish is about 3 minutes or shorter.

In certain embodiments, the activator solution further comprises a catalyst for the peroxyoxalate reaction, hereinafter referred to as a peroxyoxalate catalyst. Organic and inorganic bases with a pKb of about 14 or less may be used as the peroxyoxalate catalysts. A preferred peroxyoxalate catalyst is sodium salicylate.

In certain embodiments, the peroxyoxalate catalyst for the peroxyoxalate reaction is stored separately from the oxalate and activator compositions. The peroxyoxalate catalyst may be stored in pure state or dissolved in a suitable solvent. Examples of suitable solvents include, without limitation, water, triethyl citrate, triacetin, and any combinations thereof.

In one embodiment, an oxalate composition comprises an oxalate. In certain embodiments, the oxalate is a bis-oxalate ester having the structure of Formula I:

R₀′—O—(C═O)—(C═O)—O—R₀″ Formula I;

wherein: R₀′ and R₀″ are independently selected from the group consisting of alkyl and aryl. Examples of suitable bis-oxalate esters include, without limitation, bis(2-carbopentyloxy-3,5,6-trichlorophenyl) oxalate (CPPO) and bis(2,4,6-trichlorophenyl) oxalate (TCPO).

In certain embodiments the oxalate composition further comprises an oxalate solvent. Any solvent that dissolves or suspend the oxalate ester into a stable mixture or solution may be used. An oxalate solvent miscible with the activator solution is preferred. Examples of suitable oxalate solvents include, without limitation, benzoate, butyl benzoate, dibutyl phthalate, isoamyl benzoate, and any combinations thereof. Isoamyl benzoate is a preferred solvent for low temperatures because it has a lower melting point than butyl benzoate.

In certain embodiments, the oxalate composition further comprises a fluorescer for the emission of light. In certain embodiments, the fluorescer is an organic fluorescent compound sufficiently stable under the peroxyoxalate reaction conditions. Any fluorescent compound known in the art can be used herein.

In certain embodiments, the oxalate composition further comprises a fluorescer not stable under the peroxyoxalate reaction conditions. Many fluorescent dyes degrade quickly under the oxidizing conditions of the reaction. Examples of these types of dyes include, without limitation, thioxanthene, benzothioxanthene, xanthene, benzoxanthene, coumarin, napthalimide, phthalocyanine, cyanine, and any combinations thereof. The lifetime of many of these dyes is sufficient for the short duration chemiluminescence required for training ammunition payloads. Examples of unstable dyes that give bright chemiluminescence of sufficient duration include, without limitation, Basic Red 1, Basic Violet 10, Basic Yellow 40, Solvent Yellow 43, Solvent Yellow 140, Solvent Red 197, Fluorescent Brightener 61, Solvent Red 196, Solvent Red 149, Solvent Yellow 160, and any combinations thereof.

Another aspect of the disclosure relates to a chemiluminescent composition comprising an oxalate composition, an activator composition and a peroxyoxalate catalyst, wherein:

the oxalate composition comprises an oxalate;

the activator composition comprises at least about 2.5% H₂O₂ and an activator solvent.

In certain embodiments, the oxalate composition, the oxalate, the activator composition, the activator solvent, and the peroxyoxalate catalyst are the same as described supra.

In certain embodiments, the oxalate composition, the activator composition and the peroxyoxalate catalyst are stored separately from each other.

In certain embodiments, the oxalate composition further comprises a fluorescer as described supra.

In certain embodiments, the chemiluminescent composition does not produce heat when activated.

In certain embodiments, the chemiluminescent composition produces bright and short-duration light when activated.

In certain embodiments, the chemiluminescent composition further comprises a H₂O₂ decomposition catalyst as described supra.

Another aspect of the disclosure relates to a chemiluminescent system comprising a chemiluminescent composition disclosed herein:

an oxalate container containing an oxalate composition therein;

an activator container containing an activator composition therein;

the oxalate container and the activator container are separated by one or more frangible barriers such that, when the one or more frangible barriers are broken, the oxalate composition and the activator composition will make contact; and

the oxalate composition, and the activator composition are the same as described supra.

In certain embodiments, the chemiluminescent system further comprises a peroxyoxalate catalyst in a peroxyoxalate catalyst container separated from the oxalate container and/or the activator container by one or more frangible barriers such that when the one or more barriers are broken the peroxyoxalate catalyst will make contact with the oxalate composition and/or activator composition.

In certain embodiments, the chemiluminescent system further comprises a peroxyoxalate catalyst, and the peroxyoxalate catalyst or the peroxyoxalate catalyst container surrounds the oxalate container and/or the activator container. In certain embodiments, the peroxyoxalate catalyst container is included in the oxalate container. In certain embodiments, the peroxyoxalate catalyst container or the peroxyoxalate catalyst is placed in a separate location that will contact the solutions when the one or more frangible barriers break.

In certain embodiments, the chemiluminescent system further comprises a peroxyoxalate catalyst supported on a substrate. Examples of substrates include, without limitation, inert inorganic minerals (e.g. silica, alumina, magnesium silicate, zeolite, pumice), polymer foams (e.g. polyurethane, polyester urethane, polyether urethane, neoprene, natural gum, ethylene-propylene-diene, polyethylene, polyimide), and any combinations thereof.

In certain embodiments, the chemiluminescent system further comprises a H₂O₂-decomposition catalyst in a H₂O₂-decomposition catalyst container separated from the oxalate container and/or the activator container by one or more frangible barriers such that when the one or more barriers are broken, the H₂O₂-decomposition catalyst, the oxalate composition and the activator composition will make contact. In certain embodiments, the activator composition contained in the activator composition container further comprises a peroxyoxalate catalyst described supra, and the H₂O₂-decomposition catalyst container is separated from the oxalate container and the activator container by one or more frangible barriers such that when the one or more barriers are broken, the H₂O₂-decomposition catalyst, the oxalate composition and the activator composition comprising the peroxyoxalate catalyst will make contact.

In certain embodiments, the chemiluminescent system further comprises a H₂O₂-decomposition catalyst in a H₂O₂-decomposition catalyst container, and a peroxyoxalate catalyst in a peroxyoxalate catalyst container, wherein the H₂O₂-decomposition catalyst container, the peroxyoxalate catalyst container, the oxalate container and the activator container are separated by one or more frangible barriers such that when the one or more barriers are broken, the H₂O₂-decomposition catalyst, the oxalate composition, the peroxyoxalate catalyst and the activator composition will make contact.

In certain embodiments, the chemiluminescent system further comprises a H₂O₂-decomposition catalyst optionally in a H₂O₂-decomposition catalyst container, and the H₂O₂-decomposition catalyst or the H₂O₂-decomposition catalyst container surrounds the oxalate container and/or the activator container. In certain embodiments, the H₂O₂-decomposition catalyst container is included in the oxalate container. In certain embodiments, the H₂O₂-decomposition catalyst container or the H₂O₂-decomposition catalyst is placed in a separate location that will contact the solutions when the one or more frangible barriers break.

In certain embodiments, the chemiluminescent system further comprises a H₂O₂-decomposition catalyst supported on a substrate. Examples of substrates include, without limitation, inert inorganic minerals (e.g. silica, alumina, magnesium silicate, zeolite, pumice), polymer foams (e.g. polyurethane, polyester urethane, polyether urethane, neoprene, natural gum, ethylene-propylene-diene, polyethylene, polyimide), and any combinations thereof.

In certain embodiments, the chemiluminescent system is configured such that the H₂O₂-decomposition catalyst contacts H₂O₂ of the chemiluminescent composition before, at about the same time as, or after the peroxyoxalate reaction of the chemiluminescent composition is initiated.

Another aspect of the disclosure relates to an ammunition payload comprising a chemiluminescent system described herein. The configuration of the containers and the compositions are arranged inside the ammunition such that when the containers break, the compositions contained therein will make contact with each together. The contact may occur at any point after firing the ammunition including, without limitation, setback, muzzle exit, and impact. In certain embodiments, the ammunition payload is an ammunition training and/or marking payload. In another embodiment, the ammunition payload is a 40 mm ammunition training and/or marking payload.

Another aspect of the disclosure relates to a method for initiating a chemiluminescent system and/or a chemiluminescent composition disclosed herein comprising contacting the ingredients of the chemiluminescent system and/or the chemiluminescent composition with each other at a first temperature to initiate the peroxyoxalate reaction.

In one embodiment, the first temperature is in the same ranges as described supra. In another embodiment, the time it takes for the chemiluminescent composition to reach peak light is in the same ranges as described supra. In certain embodiments, the H₂O₂-decomposition catalyst contacts H₂O₂ of the chemiluminescent composition before, at the same time as, or after the peroxyoxalate reaction of the chemiluminescent composition is initiated.

### EXAMPLES

### Example 1. Light Generation at Cold Temperatures

An oxalate composition was prepared by combining 25 grams of bis(2-carbopentyloxy-3,5,6-trichlorophenyl) oxalate (CPPO), 0.45 grams of 1,8-dichloro-9,10-bis(phenylethynyl) anthracene, and 75 grams of isoamyl benzoate. An activator composition was prepared by combining 44 grams of 90% hydrogen peroxide with 36 grams of triethyl citrate. To the activator composition was added 0.006 grams of sodium salicylate. Both the oxalate and activator compositions were cooled to about −40° C. 1 gram of the activator composition was mixed with 2 grams of the oxalate composition, and no light was generated.

The mixture was held in a cold bath at −40° C. and placed about 1 inch away from an Extech HD 450 light meter probe. A K-type thermocouple with a 1-second response time was used to monitor temperature. A magnetic stir bar was used to mix the reaction mixture while 0.5 grams of manganese dioxide was added to the solution. Light was visible immediately. A maximum intensity of 10.8 lux and a maximum temperature of 28° C. were obtained.

The experiment was repeated at 25° C., except the activator and the manganese dioxide were added at the same time. A maximum intensity of 47 lux and a maximum temperature of 63° C. were obtained.

This example shows that in certain embodiments of the invention disclosed herein makes it possible to generate chemiluminescent light at very low temperatures (−40° C.). The light intensity was reduced from what was obtained at 25° C., but at both temperatures, light was immediately generated.

### Example 2. Chemiluminescent Compositions Having Different Hydrogen Peroxide Concentrations and Different Catalysts

The oxalate composition from Example 1 was used. The light and temperature were measured in the same way as described in Example 1. Activator compositions with hydrogen peroxide concentrations of 15%, 25%, and 50% were prepared by combining the appropriate amount of 90% hydrogen peroxide with triethyl citrate. To each activator composition was added 0.006 grams of sodium salicylate per 80 grams of activator.

1 gram of each activator composition was reacted with 2 grams of oxalate composition. The activator and oxalate were cooled to −40° C., then kept in a −40° C. cold bath while the catalyst was added. Catalyst was either 0.5 grams of powdered silver or 0.5 grams of manganese dioxide. The results are shown in Table 1.

TABLE 1
Chemiluminescent compositions having different
hydrogen peroxide concentrations

| % Hydrogen | | Max | |
|---|---|---|---|
| Peroxide in | | temperature | Peak light |
| Activator | Catalyst | (° C.) | (lux) |
| 50 | Ag | 32 | 302.7 |
| 25 | Ag | −19 | 5.5 |
| 15 | Ag | −38 | 0 |
| 50 | MnO2 | 28 | 10.8 |
| 25 | MnO2 | 0 | 1.7 |
| 15 | MnO2 | −33 | 0.3 |

These results show that the reaction rates were increased by increasing the concentration of hydrogen peroxide. The reaction rate was also influenced by the type of catalyst used. Silver was a better catalyst than manganese dioxide, especially at higher hydrogen peroxide concentrations.

### Example 3. Chemiluminescent Compositions Using a Hydrogen Peroxide Decomposition Catalyst Supported on Foam

Reticulated polyurethane foam (30 ppi) was completely submerged into a solution of 5% potassium permanganate in water. The foam was removed from the water and squeezed to remove excess moisture. The damp foam was then dried at 70° C. for 6 hours.

The oxalate composition from Example 1 was used. The light and temperature were measured in the same way as described in Example 1. Activator composition of 10% hydrogen peroxide was prepared by combining the appropriate amount of 90% hydrogen peroxide with triethyl citrate. The experiment was performed at 25° C.

1 mL of oxalate was combined with 2 mL of activator and then poured on to 0.23 grams of the foam. Light was immediately generated. The peak intensity was 222 lux and the temperature rose to 64° C. Additionally, light generation ceased after 15 seconds.

### Example 4. Chemiluminescent Compositions Using a Combination of Sodium Salicylate and Manganese Dioxide

The oxalate composition from Example 1 was used. The light and temperature were measured in the same way as described in Example 1. An activator composition with hydrogen peroxide concentration of 30% was prepared by combining the appropriate amount of 90% hydrogen peroxide with triethyl citrate. No sodium salicylate was added to the activator composition.

1 gram of activator composition and 2 grams of oxalate composition were combined and cooled to −40° C. 0.5 grams of manganese dioxide was combined with 0.125 grams of sodium salicylate. When this mixture was added to the combined activator and oxalate at −40° C., light was visible immediately. The peak light intensity was 39.8 lux, and the solution heated to 12° C.

This example shows that the peak light intensity can be increased by adding solid sodium salicylate in addition to manganese dioxide since the peak light intensity was significantly higher than any of the manganese dioxide-only systems discussed in Example 2.

### Example 5. Potassium Permanganate as Hydrogen Peroxide Decomposition Catalyst

The oxalate composition from Example 1 was used. The light was measured in the same way as described in Example 1. An activator composition with hydrogen peroxide concentration of 30% was prepared by combining 0.007 grams of sodium salicylate, 50 grams of 90% hydrogen peroxide, and 100 grams of triethyl citrate.

10 grams of activator composition and 2.5 grams of oxalate composition were combined and cooled to −40° C. No light was visible. When 0.05 grams of potassium permanganate was added to the combined activator and oxalate at −40° C., light was visible immediately. The peak light intensity was 43.4 lux.

### Example 6. Enhanced Shelf Life Obtained Through Storing Peroxyoxalate Catalyst Separately from Activator and Oxalate Solution

An activator solution with a hydrogen peroxide concentration of 2.5% was prepared by combining the appropriate amount of 70% hydrogen peroxide with triethyl citrate. Also, a 10% solution of sodium salicylate was prepared by combining 10 grams of sodium salicylate, 5 grams water, and 85 grams of triethyl citrate.

An oxalate solution was prepared by combining 25 grams of bis(2-carbopentyloxy-3,5,6-trichlorophenyl) oxalate (CPPO), 0.25 grams of rubrene, and 75 grams of butyl benzoate.

The 2.5% hydrogen peroxide activator and the 10% sodium salicylate solutions were combined in the appropriate ratios to give solutions with concentrations of 0.1% sodium salicylate, 0.3% sodium salicylate, and 0.5% sodium salicylate. 1 gram of oxalate and 2.5 grams of each concentration sodium salicylate solution were combined, and the light was measured in the same manner as Example 1. The duration until the light intensity was below 10 lux is reported.

Accelerated aging testing was conducted by placing solutions into a 65° C. oven for 114 hours. To evaluate the effect of storing the sodium salicylate as part of the activator vs. storing the sodium salicylate separately, the 0.1% sodium salicylate, 0.3% sodium salicylate, and 0.5% sodium salicylate solutions were aged in parallel with the 2.5% hydrogen peroxide activator solution and the 10% sodium salicylate solution. The solutions were allowed to cool to room temperature, then the 2.5% hydrogen peroxide activator solution and the 10% sodium salicylate solutions that had been stored separately were combined to give new 0.1% sodium salicylate, 0.3% sodium salicylate, and 0.5% sodium salicylate solutions. Once again, the duration was measured by combining 1 gram of oxalate with 2.5 grams of the aged sodium salicylate solutions.

TABLE 2
Test of compositions having peroxyoxalate catalyst
separately from activator and oxalate solution

| | | Duration after | Duration after |
|---|---|---|---|
| | | accelerated | accelerated |
| | | aging with sodium | aging with sodium |
| | Initial | salicylate | salicylate stored |
| % sodium | duration | as part of | separately from |
| salicylate | (min) | activator (min) | activator (min) |
| 0.1 | 0:35 | 4:44 | 0:37 |
| 0.3 | 0:13 | 2:00 | 0:13 |
| 0.5 | 0:13 | 1:25 | 0:13 |

The data showed that the performance of the solutions where sodium salicylate was included in the activator changed significantly upon accelerated aging. The duration of the reaction increased for all concentrations of sodium salicylate tested. However, when the sodium salicylate solution was stored separately from the 2.5% hydrogen peroxide solution during the accelerated aging test, the duration of the aged solutions was very similar to the initial performance.

### Example 7. Enhanced Short-Duration Chemiluminescence Through Use of Unstable Dyes

Two oxalate solutions using dyes that emit green light were prepared. Oxalate 1 used 2-methyl-9,10-bis (phenylethynyl)anthracene (MBPEA), a commonly used dye for chemiluminescence. Oxalate 2 used Solvent Yellow 43, an unstable dye. The oxalates were prepared by combining 10 grams of bis(2-carbopentyloxy-3,5,6-trichlorophenyl) oxalate (CPPO), 29.82 grams of butyl benzoate, and 0.18 grams of the appropriate dye.

Two activator solutions were prepared. A long-duration activator solution with a hydrogen peroxide concentration of 2.5% was prepared by combining the appropriate amount of 70% hydrogen peroxide with triethyl citrate and adding a concentration of catalyst that typically resulted in light emission over a period of 12 hours. A short-duration activator solution with a hydrogen peroxide concentration of 2.5% was prepared by combining the appropriate amount of 70% hydrogen peroxide with triethyl citrate and 0.1% sodium salicylate.

Three grams of each oxalate solution was combined with 7 grams of long-duration activator. The light intensity was measured in the same manner described in Example 1. Table 3 shows that while the formulation containing MBPEA oxalate continued to emit light for over 10 hours, the light from the Solvent Yellow 43 formulation ceased after 10 minutes. This shows the inadequacy of Solvent Yellow 43 for typical chemiluminescent applications.

TABLE 3
Performance of compositions containing unstable dyes.

| | Intensity (lux) | | | | | | | | |
|---|---|---|---|---|---|---|---|---|---|
| | | 5 min | 10 min | 1 hr | 2 hr | 4 hr | 6 hr | 8 hr | 10 hr |
| | | after | after | after | after | after | after | after | after |
| | Peak | initiation | initiation | initiation | initiation | initiation | initiation | initiation | initiation |
| Oxalate 1 | 58.5 | 19.9 | 14.3 | 7.1 | 5.4 | 4.1 | 3.0 | 2.0 | 1.0 |
| (MBPEA) | | | | | | | | | |
| Oxalate 2 | 30.8 | 0.8 | 0.2 | 0 | 0 | 0 | 0 | 0 | 0 |
| (Solvent | | | | | | | | | |
| Yellow 43) | | | | | | | | | |

In another experiment, three grams of each oxalate solution was combined with 7 grams of short-duration activator. The light intensity was measured in the same manner described in Example 1. Table 4 shows that the formulation containing Solvent Yellow 43 had much brighter peak intensity and shorter duration than the formulation containing MBPEA. This shows that Solvent Yellow 43 was an excellent dye for high intensity, short duration chemiluminescent formulations.

TABLE 4
Performance of compositions containing unstable dyes.

| | Intensity (lux) | | | | | | |
|---|---|---|---|---|---|---|---|
| | | 1 min | 2 min | 5 min | 10 min | 15 min | 20 min |
| | | after | after | after | after | after | after |
| | Peak | initiation | initiation | initiation | initiation | initiation | initiation |
| Oxalate 1 | 534 | 146 | 107 | 78 | 41 | 6 | 0 |
| (MBPEA) | | | | | | | |
| Oxalate 2 | 1310 | 107 | 50 | 13 | 0 | 0 | 0 |
| (Solvent | | | | | | | |
| Yellow 43) | | | | | | | |

It should be appreciated that the specific embodiments of the disclosure have been described herein for purposes of illustration only, and not for limitation. Various modifications may be made without deviating from the spirit and scope of the disclosure. Furthermore, while various advantages associated with certain embodiments of the disclosure have been described above in the context of those embodiments, other embodiments may also exhibit such advantages, and not all embodiments need necessarily exhibit all such advantages to fall within the scope of the disclosure.

1. A chemiluminescent composition comprising an oxalate composition, an activator composition and a H₂O₂-decomposition catalyst, wherein:
the oxalate composition comprises an oxalate; and
the activator composition comprises at least about 2.5% H₂O₂ and an activator solvent.

2. The chemiluminescent composition according to claim 1 wherein the H₂O₂ decomposition catalyst is selected from the group consisting of manganese dioxide, silver, potassium permanganate, and any combinations thereof.

3. (canceled)

4. The chemiluminescent composition according to claim 1, wherein the H₂O₂ decomposition catalyst is supported on a substrate selected from the group consisting of polymer foam, inert inorganic minerals and any combinations thereof.

5. The chemiluminescent composition according to claim 1, further comprising a fluorescer.

6. The chemiluminescent composition according to claim 1, wherein:
the oxalate composition optionally further comprises an oxalate solvent that dissolves or suspends the oxalate composition; and
the activator solvent is selected from the group consisting of triethyl citrate, triacetin, and any combinations thereof.

7. The chemiluminescent composition according to claim 6, wherein the oxalate solvent is selected from the group consisting of benzoate, butyl benzoate, dibutyl phthalate, isoamyl benzoate, and any combinations thereof.

8. A chemiluminescent system comprising the chemiluminescent composition according to claim 1, further comprising:
an oxalate container containing the oxalate composition therein; and
an activator container containing the activator composition therein;
wherein the oxalate container and the activator container are separated by one or more frangible barriers such that when broken the oxalate composition and the activator composition will make contact.

9. The chemiluminescent system according to claim 8, further comprising a separate H₂O₂-decomposition catalyst container containing the H₂O₂-decomposition catalyst therein, and when the H₂O₂-decomposition catalyst container, the oxalate container and/or the activator container are broken, the H₂O₂-decomposition catalyst, the oxalate composition and the activator composition will make contact.

10. The chemiluminescent system according to claim 8, wherein the ingredients of the chemiluminescent composition thereof can contact each other at a first temperature to initiate a peroxyoxalate reaction.

11. The chemiluminescent system according to claim 10, wherein the first temperature is about −40° C. or higher.

12. The chemiluminescent system according to claim 8, wherein the chemiluminescent system reaches its peak light within 10 seconds after the ingredients of the chemiluminescent composition thereof contact each other.

13. An ammunition payload comprising a chemiluminescent system according to claim 8.

14.-16. (canceled)

17. A chemiluminescent composition comprising an oxalate composition, an activator composition, and a peroxyoxalate catalyst, wherein:
the oxalate composition comprises an oxalate;
the activator composition comprises at least about 2.5% H₂O₂ and an activator solvent; and
the oxalate composition, the activator composition and the peroxyoxalate catalyst are stored separately from each other.

18. The chemiluminescent system according to claim 17, wherein the peroxyoxalate catalyst is stored in pure state or dissolved in a solvent.

19. The chemiluminescent system according to claim 17, wherein the peroxyoxalate catalyst is an organic or inorganic base with a pKb of about 14 or less.

20. A chemiluminescent system comprising the chemiluminescent composition according to claim 17, further comprising:
an oxalate container containing the oxalate composition therein;
an activator container containing the activator composition therein; and
a peroxyoxalate catalyst container containing the peroxyoxalate composition therein;
wherein the oxalate container, the activator container, and the peroxyoxalate catalyst container are separated by one or more frangible barriers such that when broken the oxalate composition, the activator composition, and the peroxyoxalate catalyst composition will make contact.

21. An ammunition payload comprising a chemiluminescent system according to claim 17.

22. The chemiluminescent system according to claim 1 further comprising a fluorescer.

23. The chemiluminescent system according to claim 22, wherein the fluorescer is a dye comprising a structure selected from the group consisting of: thioxanthene, benzothioxanthene, xanthene, benzoxanthene, coumarin, napthalimide, phthalocyanine, and cyanine.

24. The chemiluminescent system according to claim 23 wherein the fluorescer is Solvent Yellow 43 or Solvent Yellow 160.

25. The chemiluminescent system according to claim 17 further comprising a fluorescer.

26. The chemiluminescent system according to claim 25, wherein the fluorescer is a dye comprising a structure selected from the group consisting of: thioxanthene, benzothioxanthene, xanthene, benzoxanthene, coumarin, napthalimide, phthalocyanine, and cyanine.

27. The chemiluminescent system according to claim 26 wherein the fluorescer is Solvent Yellow 43 or Solvent Yellow 160.

28. The chemiluminescent composition according to claim 1, wherein the oxalate composition comprises the H₂O₂-decomposition catalyst.
